(19) United States
(12) Patent Application Publication
(10) Pub. No.: US 2003/0156875 A1
(43) Pub. Date: Aug. 21, 2003

(54) Printing apparatus, information processing apparatus, control method therefor, printing system, and program

(75) Inventor: Naoshi Inoue, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/361,597

(22) Filed: Feb. 11, 2003

(30) Foreign Application Priority Data
Feb. 15, 2002 (JP) 2002-039032

(51) Int. Cl. B41J 3/42

(52) U.S. Cl. 400/74

(57) ABSTRACT

A printing apparatus detects the execution timing of maintenance in the apparatus, and on the basis of the detection result, transmits to a host computer external device a first command that requests execution of maintenance. The apparatus receives a second command which corresponds to the first command and instructs execution of the maintenance. When the second command is received, a maintenance section executes the maintenance to be executed under the control of a maintenance control section.

### FIELD OF THE INVENTION

The present invention relates to a printing apparatus having a maintenance operation of executing maintenance of components or mechanisms in the apparatus, an information processing apparatus for controlling the printing apparatus, a printing system having the printing apparatus and information processing apparatus, a control method therefor, and a program.

### BACKGROUND OF THE INVENTION

Conventionally, in the form of a printer connected to a terminal such as a host computer, maintenance is automatically performed only on the printer side.

However, when a printer is used as the printing section of a commercial device or the like, it may result in a trouble if the printer, which functions as a printing section in the operation of the entire system, arbitrarily performs maintenance. For example, when printing paper convey is controlled on the main body (host computer) side, the convey timing and printing timing must be accurately adjusted. In such a system, if the printing section executes maintenance by itself, the convey timing cannot be calculated.

### SUMMARY OF THE INVENTION

The present invention has been made to solve the above problem, and has as its object to provide a printing apparatus, an information processing apparatus, a control method therefor, a printing system, and a program, which can execute maintenance of the printing apparatus at an appropriate timing and increase the throughput of the entire system.

According to the present invention, the foregoing object is attained by providing a printing apparatus having a maintenance operation of executing maintenance of components or mechanisms in the apparatus, comprising:

detection means for detecting an execution timing of maintenance in the apparatus;

transmission means for transmitting to an external device a first command that requests execution of the maintenance on the basis of a detection result from the detection means;

reception means for receiving from the external device a second command which corresponds to the first command and instructs execution of the maintenance; and

execution means for, when the reception means receives the second command, executing maintenance to be executed.

In a preferred embodiment, the apparatus further comprises holding means for, when the detection means detects the execution timing of the maintenance, holding a flag representing a type of the maintenance, and

when the receiving means receives the second command, the execution means executes maintenance corresponding to the flag held by the holding means as the maintenance to be executed.

According to the present invention, the foregoing object is attained by providing an information processing apparatus for controlling a printing apparatus having a maintenance operation of executing maintenance of components or mechanisms in the apparatus, comprising:

reception means for receiving a first command that requests execution of maintenance from the printing apparatus;

determination means for, upon receiving the first command, determining whether the maintenance can be executed; and

transmission means for transmitting a second command that instructs execution of the maintenance to the printing apparatus on the basis of a determination result from the determination means.

According to the present invention, the foregoing object is attained by providing a printing system having a printing apparatus having a maintenance operation of executing maintenance of components or mechanisms in the apparatus and an external device for controlling the printing apparatus, wherein

the printing apparatus comprises

detection means for detecting an execution timing of maintenance in the apparatus,

first transmission means for transmitting to the external device a first command that requests execution of the maintenance on the basis of a detection result from the detection means,

first reception means for receiving from the external device a second command which corresponds to the first command and instructs execution of the maintenance, and

execution means for, when the first reception means receives the second command, executing maintenance to be executed, and

the external device comprises

second reception means for receiving the first command from the printing apparatus,

determination means for, upon receiving the first command, determining whether the maintenance can be executed, and

second transmission means for transmitting the second command to the printing apparatus on the basis of a determination result from the determination means.

According to the present invention, the foregoing object is attained by providing a printing apparatus having a maintenance operation of executing maintenance of components or mechanisms in the apparatus, comprising:

detection means for detecting an execution timing of maintenance in the apparatus;

holding means for holding a flag to request execution of the maintenance on the basis of a detection result from the detection means;

transmission means for receiving from an external device a status request for the printing apparatus and, when the holding means holds the flag, transmitting a status containing the flag to the external device;

reception means for receiving from the external device a command which corresponds to the flag and instructs execution of the maintenance; and

execution means for, when the reception means receives the command, executing maintenance to be executed.

In a preferred embodiment, when the detection means detects the execution timing of the maintenance, the holding means also holds a flag representing a type of the maintenance, and

when the reception means receives the command, the execution means executes maintenance corresponding to the flag held by the holding means as the maintenance to be executed.

In a preferred embodiment, the printing apparatus is an inkjet printing apparatus, and

the maintenance includes at least an arbitrary combination of wiping operation, predischarge operation, cleaning operation, and capping operation for a printhead of the printing apparatus.

According to the present invention, the foregoing object is attained by providing an information processing apparatus for controlling a printing apparatus having a maintenance operation of executing maintenance of components or mechanisms in the apparatus, comprising:

reception means for requesting and receiving a status of the printing apparatus;

determination means for, when a flag to request execution of maintenance is contained in the status, determining whether the maintenance can be executed; and

transmission means for transmitting a command that instructs execution of the maintenance to the printing apparatus on the basis of a determination result from the determination means.

According to the present invention, the foregoing object is attained by providing a printing system having a printing apparatus having a maintenance operation of executing maintenance of components or mechanisms in the apparatus and an external device for controlling the printing apparatus, wherein

the printing apparatus comprises

detection means for detecting an execution timing of maintenance in the apparatus,

holding means for holding a flag to request execution of the maintenance on the basis of a detection result from the detection means,

first transmission means for receiving from the external device a status request for the printing apparatus and, when the holding means holds the flag, transmitting a status containing the flag to the external device,

first reception means for receiving a command which corresponds to the flag and instructs execution of the maintenance, and

execution means for, when the first reception means receives the command, executing maintenance to be executed, and

the external device comprises

second reception means for requesting and receiving a status of the printing apparatus,

determination means for, when the flag is contained in the status, determining whether the maintenance can be executed, and

second transmission means for transmitting a command that instructs execution of the maintenance to the printing apparatus on the basis of a determination result from the determination means.

According to the present invention, the foregoing object is attained by providing a method of controlling a printing apparatus having a maintenance operation of executing maintenance of components or mechanisms in the apparatus, comprising:

a detection step of detecting an execution timing of maintenance in the apparatus;

a transmission step of transmitting to an external device a first command that requests execution of the maintenance on the basis of a detection result in the detection step;

a reception step of receiving from the external device a second command which corresponds to the first command and instructs execution of the maintenance; and

a execution step of, when the second command is received in the second step, executing maintenance to be executed.

According to the present invention, the foregoing object is attained by providing a method of controlling a method of controlling an information processing apparatus for controlling a printing apparatus having a maintenance operation of executing maintenance of components or mechanisms in the apparatus, comprising:

a reception step of receiving a first command that requests execution of maintenance from the printing apparatus;

a determination step of, upon receiving the first command, determining whether the maintenance can be executed; and

a transmission step of transmitting a second command that instructs execution of the maintenance to the printing apparatus on the basis of a determination result in the determination step.

According to the present invention, the foregoing object is attained by providing a method of controlling a method of controlling a printing apparatus having a maintenance operation of executing maintenance of components or mechanisms in the apparatus, comprising:

a detection step of detecting an execution timing of maintenance in the apparatus;

a holding step of holding a flag to request execution of the maintenance in a recording medium on the basis of a detection result in the detection step;

a transmission step of receiving from an external device a status request for the printing apparatus and, when the flag is held in the holding step, transmitting a status containing the flag to the external device;

a reception step of receiving a command which corresponds to the flag and instructs execution of the maintenance; and

an execution step of, when the command is received in the reception step, executing maintenance to be executed.

According to the present invention, the foregoing object is attained by providing a method of controlling a method of controlling an information processing apparatus for controlling a printing apparatus having a maintenance operation of executing maintenance of components or mechanisms in the apparatus, comprising:

a reception step of requesting and receiving a status of the printing apparatus;

a determination step of, when a flag to request execution of maintenance is contained in the status, determining whether the maintenance can be executed; and

a transmission step of transmitting a command that instructs execution of the maintenance to the printing apparatus on the basis of a determination result in the determination step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the configuration of a printing system according to the first embodiment of the present invention;

FIG. 2 is a flow chart showing main processing executed by a printing apparatus according to the first embodiment of the present invention;

FIG. 3 is a flow chart showing timer management processing executed by the printing apparatus according to the first embodiment of the present invention;

FIG. 4 is a flow chart showing print processing executed by the printing apparatus according to the first embodiment of the present invention;

FIG. 5 is a flow chart showing maintenance request processing executed by the printing apparatus according to the first embodiment of the present invention;

FIG. 6 is a flow chart showing maintenance execution processing executed by the printing apparatus according to the first embodiment of the present invention;

FIG. 7 is a flow chart showing main processing executed by a host computer according to the first embodiment of the present invention;

FIG. 8 is a flow chart showing maintenance response processing executed by the host computer according to the first embodiment of the present invention;

FIG. 9 is a flow chart showing continuous processing executed by the host computer according to the first embodiment of the present invention;

FIG. 10 is a flow chart showing maintenance request reservation processing executed by a printing apparatus according to the second embodiment of the present invention;

FIG. 11 is a flow chart showing main processing executed by a host computer according to the second embodiment of the present invention; and

FIG. 12 is a flow chart showing status notification processing executed by the printing apparatus according to the second embodiment of the present invention.

### DETAILED DESCRIPTION OF THE PREFERRED EMBODIMENTS

Preferred embodiments of the present invention will be described below in detail with reference to the accompanying drawings.

(First Embodiment)

The present invention is a printing apparatus having a printing function capable of printing on a printing paper sheet and a maintenance function of executing maintenance of components or mechanisms in the apparatus. Examples of the printing scheme of a printing apparatus are an inkjet scheme, laser beam scheme, and thermal transfer scheme.

In the first embodiment, an inkjet printing apparatus will be exemplified. The present invention is not limited to this and can also be applied to, e.g., a printing apparatus of another printing scheme, or a facsimile apparatus or copying machine having the printing apparatus.

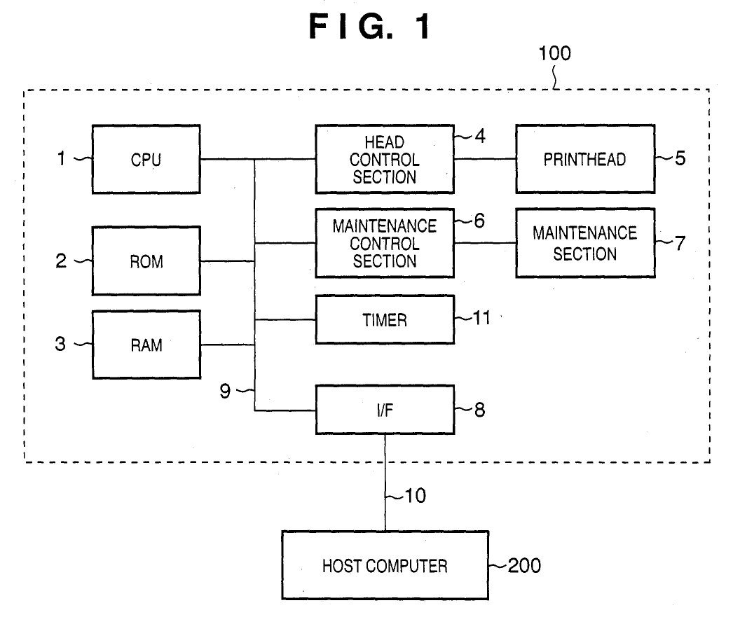

FIG. 1 is a block diagram showing the configuration of a printing system according to the first embodiment of the present invention.

In a printing apparatus 100, a CPU 1 controls various constituent elements of the printing apparatus 100. This control is implemented by, e.g., reading out and executing a control program stored in a ROM 2. The ROM 2 stores various control programs including programs used to execute flow charts to be described later. A RAM 3 functions as a temporary save area for various kinds of data or a work area for processing executed by the control programs.

A head control section 4 controls the printing operation of a printhead 5. The printhead 5 prints by the inkjet scheme. A maintenance control section 6 detects a maintenance execution timing and controls various maintenance operations for the printing apparatus 100 on the basis of the detection result. A maintenance section 7 executes various maintenance operations for the components of the printing apparatus 100. As such maintenance operations, the first embodiment assumes four kinds of maintenance including, e.g., wiping operation, predischarge operation, cleaning operation, and capping operation for the printhead 5.

An interface (I/F) 8 connects an external device (host computer 200) to the printing apparatus 100 through a communication line and functions as a transmission/reception path for various kinds of data.

Examples of the interface 8 are various kinds of interfaces of centronics standard, USB standard, or IEEE1394 standard, cable network interfaces such as Ethernet (registered trademark), and radio network interfaces such as IrDA and Bluetooth (registered trademark).

A system bus 9 connects the constituent elements of the printing apparatus 100 to each other. Reference numeral 10 denotes an interface bus. A timer 11 defines the detection period at which the execution timings of various maintenance operations are detected.

The host computer 200 controls the printing apparatus 100 by generating print data to be transmitted to the printing apparatus 100 or sending various replies to requests from the printing apparatus 100.

The host computer 200 has standard constituent elements (e.g., a CPU, RAM, ROM, hard disk, external storage device, network interface, display, keyboard, mouse, and the like) of a general-purpose computer (information processing apparatus).

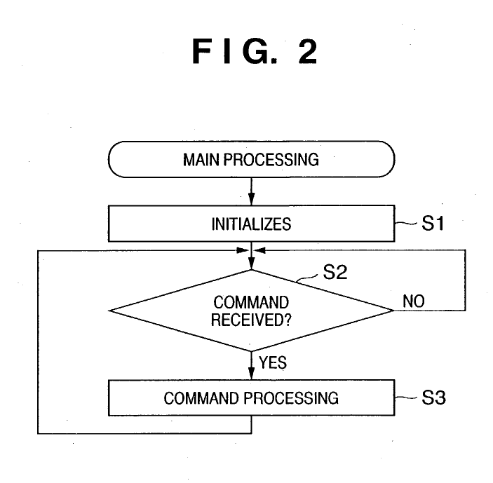

Processing executed by the printing system of the first embodiment will be described next with reference to the flow charts shown in FIGS. 2 to 9.

FIGS. 2 to 6 are flow charts showing processing executed by the printing apparatus 100. The processing described in these flow charts may be implemented by causing the CPU 1 to execute programs stored in the ROM 2 in the printing apparatus 100 or an external storage device. Alternatively, the processing may be implemented by dedicated hardware.

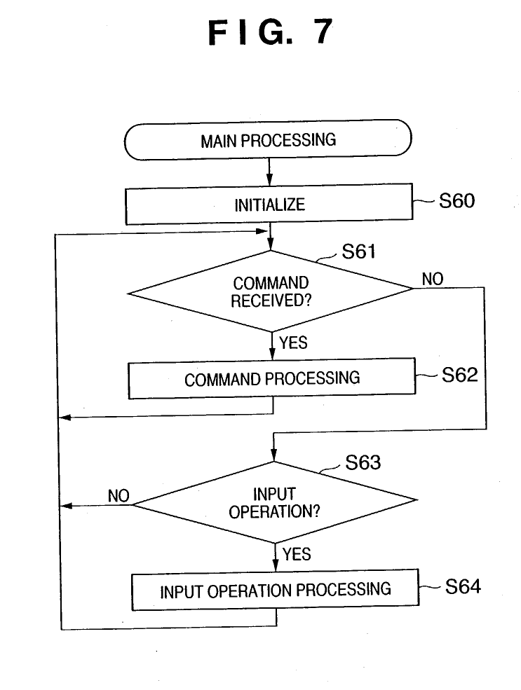

FIGS. 7 to 9 are flow charts showing processing executed by the host computer 200. The processing described in these flow charts may be implemented by causing a CPU to execute programs (including a printer driver) stored in a ROM in the host computer 200 or an external storage device. Alternatively, the processing may be implemented by dedicated hardware.

FIG. 2 is a flow chart showing main processing executed by the printing apparatus according to the first embodiment of the present invention.

In step S1, the CPU 1 initializes the head control section 4 and maintenance control section 6. In step S2, a command reception state is set. The CPU 1 monitors the interface 8 and determines the presence/absence of a command received from the host computer 200. If no command is received (NO in step S2), processing wants until a command is received. If a command is received (YES in step S2), the-flow advances to step S3 to execute command processing corresponding to the received command. When the command processing is ended, the flow returns to step S2.

The received command includes various commands such as a printing command which instructs execution of printing from the host computer 200 and a maintenance execution command for a maintenance request command that requests execution of maintenance.

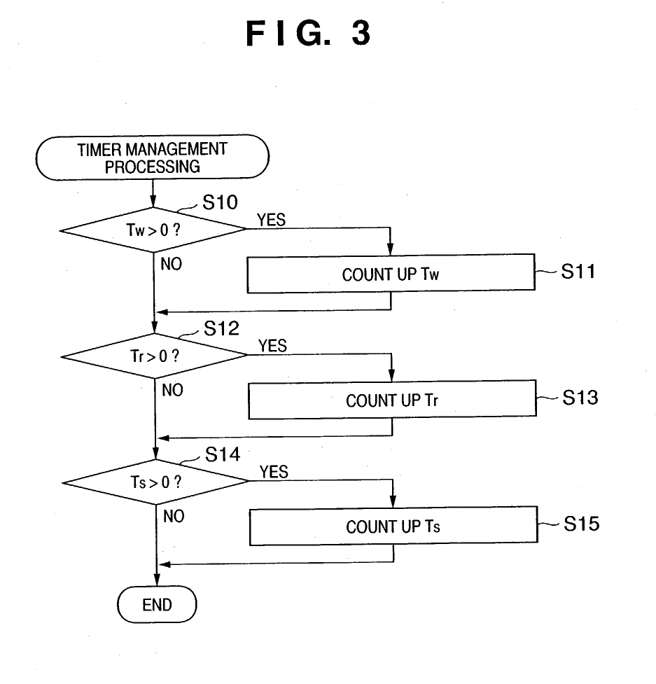

FIG. 3 is a flow chart showing timer management processing executed by the printing apparatus according to the first embodiment of the present invention.

In the first embodiment, to determine the execution timings for various maintenance operations execute to maintain the components and mechanisms in the printing apparatus 100, the timer 11 that is activated periodically (e.g., at a period of 1 msec) is prepared. As described above, there are four kinds of maintenance, i.e., wiping operation, predischarge operation, cleaning operation, and capping operation. As timer management variables for determining the execution timings of various maintenance operations, a wiping timer Tw, capping timer Tr, and predischarge timer Ts are defined.

In step S10, the CPU 1 determines whether the wiping timer Tw is 0 or more (count-up state). If the wiping timer Tw is 0 or more (YES in step S10), the flow advances to step S11 to count up the wiping timer Tw.

If the wiping timer Tw is less than 0 (NO in step S10), the flow advances to step S12. The CPU 1 determines whether the capping timer Tr is 0 or more. If the capping timer Tr is 0 or more (YES in step S12), the flow advances to step S13 to count up the capping timer Tr.

If the capping timer Tr is less than 0 (NO in step S12), the flow advances to step S14. The CPU 1 determines whether the predischarge timer Ts is 0 or more. If the predischarge timer Ts is 0 or more (YES in step S14), the flow advances to step S15 to count up the predischarge timer Ts. Then, the processing is ended.

If the predischarge timer Ts is less than 0 (NO in step S14), the processing is ended.

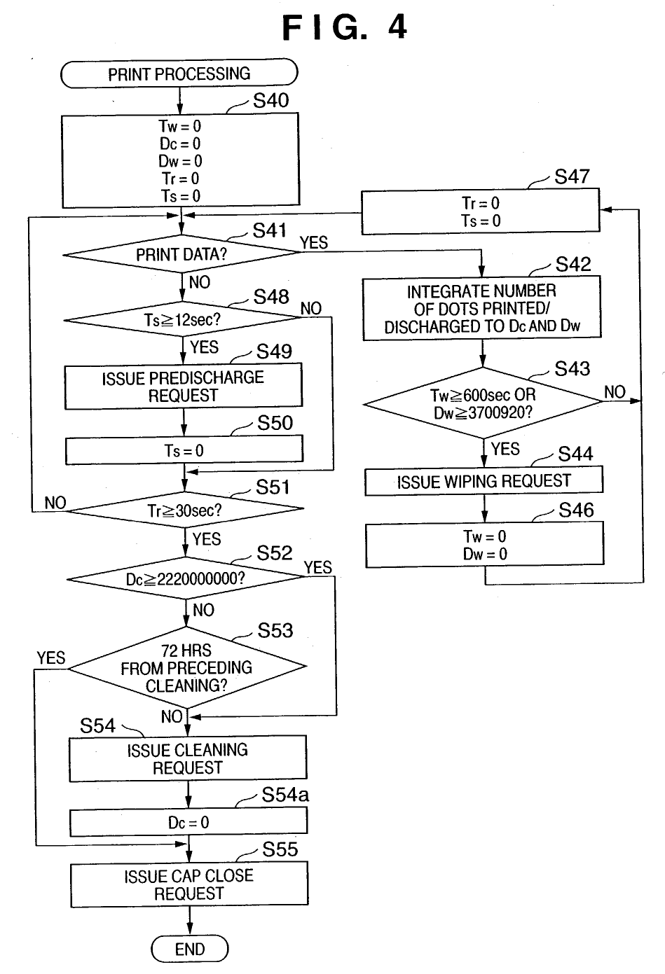

As one of command processing operations, print processing executed upon receiving a printing command from the host computer 200 in step S2 of FIG. 2 will be described next with reference to FIG. 4.

FIG. 4 is a flow chart showing print processing executed by the printing apparatus according to the first embodiment of the present invention.

In step S40, the CPU 1 clears the timers Tw, Tr, and Ts to 0 and causes them to start counting. Cleaning dots count Dc and wiping dots count indicating are also cleared to 0, each of which is a total number of dots discharged from the printhead 5 for determining a execution timing of each of cleaning operation and wiping operation

In step S41, the CPU 1 monitors the interface 8 and determines the presence/absence of print data from the host computer 200. If print data is present (YES in step S41), the flow advances to step S42. On the basis of the print data, the CPU 1 controls the head control section 4 to cause the printhead 5 to print on a printing paper sheet. The total number of discharged dots of ink for this printing is integrated to Dc and Dw. In step S43, the CPU 1 determines whether the wiping timer Tw has a predetermined value (e.g., 600 sec) or more, or the wiping dots count Dw has a predetermined value (e.g., 3,700,920) or more. This process is done to determine the necessity of maintenance.

If one of the above determination items in step S43 is satisfied, the flow advances to step S44. The CPU 1 issues a wiping request to execute wiping operation. In step S46, the wiping timer Tw and the wiping dots count Dw are cleared to 0. In step S47, the capping timer Tr and predischarge timer Ts are cleared to 0. The flow returns to step S41.

On the other hand, if it is determined in step S41 that no print data from the host computer 200 is present, a standby state is set, and the flow advances to step S48.

In step S48, the CPU 1 controls the maintenance control section 6 to determine whether the predischarge timer Ts has a predetermined value (e.g., 12 sec) or more. If the value is less than 12 sec (NO in step S48), the flow advances to step S51. If the value is 12 sec or more (YES in step S48), the flow advances to step S49 to issue a predischarge request. Next, in step S50, the predischarge timer Ts is cleared to 0.

In step S51, the CPU 1 controls the maintenance control section 6 to determine whether the capping timer Tr has a predetermined value (e.g., 30 sec) or more. If the value is less than 30 sec (NO in step S51), the flow returns to step S41. If the value is 30 sec or more (YES in step S51), the flow advances to step S52.

In step S52, the CPU 1 controls the maintenance control section 6 to determine whether the cleaning dots count Dc has a predetermined value (e.g., 2,220,000,000) or more. If the total number D of dots discharged is 2,220,000,000 or more (YES in step S52), the flow advances to step S54. If the total number D of dots discharged is less than 2,220,000,000 (NO in step S52), the flow advances to step S53.

In step S53, the CPU 1 controls the maintenance control section 6 to determine whether a predetermined time (e.g., 72 hrs) has elapsed from the preceding cleaning operation. If 72 hrs have elapsed (YES in step S53), the flow advances to step S55. If 72 hrs have not elapsed yet (NO in step S53), the flow advances to step S54 to issue a cleaning request to execute cleaning operation. In step 54a, the cleaning dots count Dc is cleared to 0. Subsequently, in step S55, the CPU 1 issues a cap close request to execute cap close operation. Then, the print processing is ended.

The predetermined values described in FIG. 4 are mere examples and are not limited to these examples. That is, the values can be appropriately set in accordance with the application purpose or object of the printing apparatus using the operation section of the printing apparatus 100 or host computer 200.

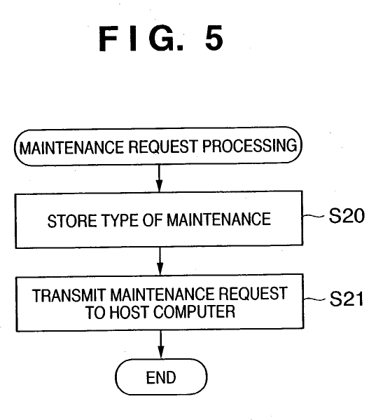

When various maintenance requests described in FIG. 4 are issued, the printing apparatus 100 executes maintenance request processing. This maintenance request processing will be described with reference to FIG. 5.

FIG. 5 is a flow chart showing maintenance request processing executed by the printing apparatus according to the first embodiment of the present invention.

In step S20, the CPU 1 stores a flag representing the type of maintenance (in this case, wiping, predischarge, cleaning or cappng) in an internal variable on the RAM 3. In step S21, a maintenance request command is transmitted to the host computer 200.

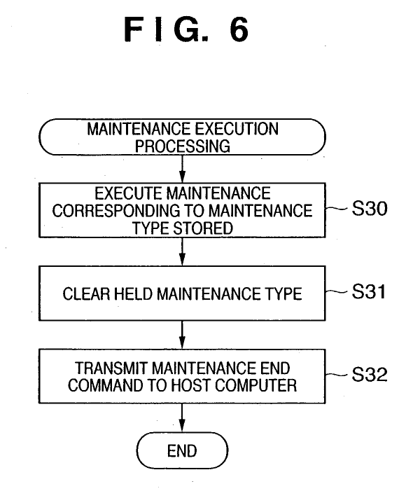

Upon receiving, from the host computer 200, a maintenance execution command corresponding to the maintenance request command transmitted to the host computer 200, the printing apparatus 100 executes maintenance execution processing. This maintenance execution processing will be described with reference to FIG. 6.

FIG. 6 is a flow chart showing maintenance execution processing executed by the printing apparatus according to the first embodiment of the present invention.

In step S30, the CPU 1 reads out the flag representing the type of maintenance, which is stored in the internal variable on the RAM 3, and causes the maintenance section 7 to execute maintenance corresponding to the flag by controlling the maintenance control section 6. In step S31, the flag stored in the internal variable on the RAM 3 is cleared. In step S32, when the maintenance is ended, a maintenance end command representing it is transmitted to the host computer 200. Then, the processing is ended.

On the other hand, upon receiving the maintenance request command from the printing apparatus 100, the host computer 200 executes main processing. This main processing will be described with reference to FIG. 7.

FIG. 7 is a flow chart showing main processing executed by the host computer according to the first embodiment of the present invention.

In step S60, the CPU of the host computer 200 initializes the system. In step S61, a command reception state is set to determine the presence/absence of a received command from the printing apparatus 100. If no command is received (NO in step S61), the flow advances to step S63. If a command is received (YES in step S61), the flow advances to step S62 to execute command processing corresponding to the received command.

In step S63, the presence/absence of input operation is determined. If no input operation is performed (NO in step S63), the flow returns to step S61. If input operation is performed (YES in step S63), the flow advances to step S64 to execute input operation processing corresponding to the input operation. Then, the flow returns to step S61.

The input operation includes various data input operations from the keyboard or mouse of the host computer 200, input operation for the GUI displayed on the monitor, instruction input operation to execute various kinds of processing such as printing command issue and data write/read to be implemented on the host computer 200.

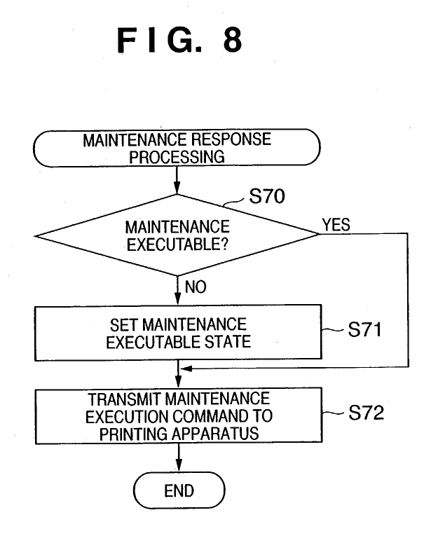

Upon receiving the maintenance request command from the printing apparatus 100 in step S61 of FIG. 7, the host computer 200 executes maintenance response processing of sending a reply to the request as one of command processing operations. This maintenance response processing will be described with reference to FIG. 8.

FIG. 8 is a flow chart showing maintenance response processing executed by the host computer according to the first embodiment of the present invention.

In step S70, upon receiving the maintenance request command from the printing apparatus 100, the CPU determines whether maintenance of the printing apparatus 100 can be executed. If maintenance can be executed (YES in step S70), the flow advances to step S72. If maintenance cannot be executed (NO in step S70), the flow advances to step S71 to set a maintenance executable state.

In step S72, a maintenance execution command that instructs execution of maintenance is issued and transmitted to the printing apparatus 100.

The determination in step S70 is done on the basis of the status of the printing apparatus 100 and the contents of processing that is being executed by the host computer 200. For example, when the host computer 200 is executing processing other than control of the printing apparatus 100, it is determined that maintenance cannot be executed.

In the processing of step S71, processing that is being currently executed by the host computer 200 is interrupted to set such a state that maintenance can be executed with priority. Otherwise, the maintenance operation by the printing apparatus 100 may be suspended or the maintenance request may be neglected until the processing currently executed by the host computer 200 is ended.

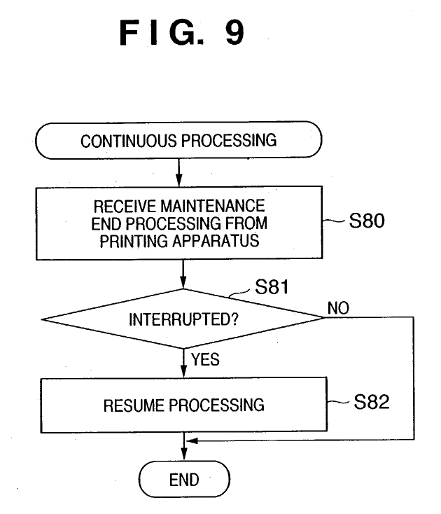

After issuing the maintenance execution command, upon receiving a maintenance end command from the printing apparatus 100, the host computer 200 executes continuous processing in accordance with the presence/absence of interrupted processing. This continuous processing will be described with reference to FIG. 9.

FIG. 9 is a flow chart showing continuous processing executed by the host computer according to the first embodiment of the present invention.

In step S80, the maintenance end command is received from the printing apparatus 100. In step S81, the presence/absence of interrupted processing is determined. If interrupted processing is present (YES in step S81), the flow advances to step S82 to resume the processing. If no interrupted processing is present (NO in step S81), the processing is ended.

As described above, according to the first embodiment, the printing apparatus 100 detects the maintenance execution timing and notifies the host computer 200 of the maintenance execution request. The maintenance is executed only after a maintenance execution instruction is received from the host computer. Accordingly, the printing apparatus 100 need not manage its maintenance operation. In addition, the host computer 200 need not grasp maintenance unique to the printing apparatus 100. As a result, the systems can independently be constructed. Even when the printing apparatus 100 is arranged as the printing section of an industrial device or the like, maintenance unique to the printing section can easily be implemented.

(Second Embodiment)

In the first embodiment, a maintenance request command is transmitted from the printing apparatus 100 to the host computer 200. A maintenance execution command corresponding to the maintenance request command is transmitted from the host computer 200 to the printing apparatus 100. The maintenance execution timing of the printing apparatus 100 is thus controlled.

In the second embodiment, a host computer 200 periodically polls the status of a printing apparatus 100 to detect the maintenance execution timing and transmits a maintenance execution command to the printing apparatus 100 on the basis of the detection result, thereby controlling the maintenance execution timing of the printing apparatus.

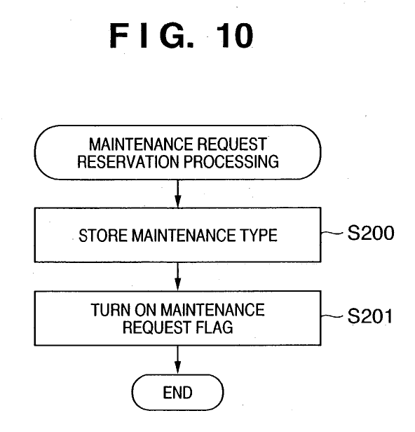

Processing executed by a printing system according to the second embodiment will be described next with reference to FIGS. 10 to 12.

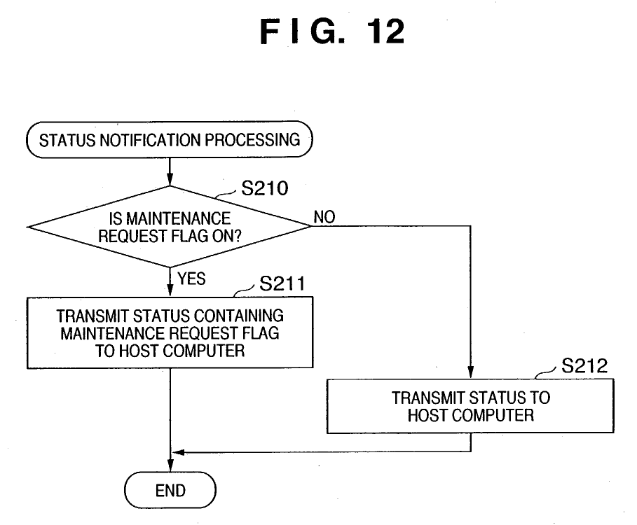

FIGS. 10 and 12 are flow charts showing processing executed by the printing apparatus 100. The processing described in these flow charts may be implemented by causing a CPU 1 to execute programs stored in a ROM 2 in the printing apparatus 100 or an external storage device. Alternatively, the processing may be implemented by dedicated hardware.

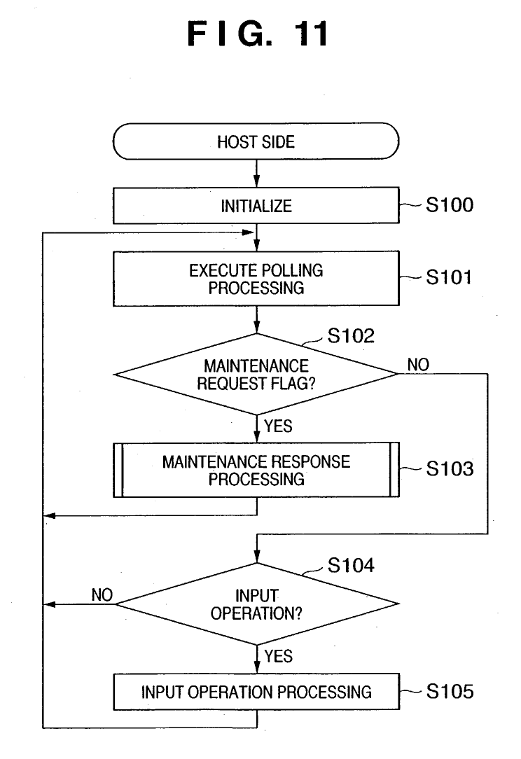

FIG. 11 is a flow chart showing processing executed by the host computer 200. The processing described in this flow chart may be implemented by causing a CPU to execute programs stored in a ROM in the host computer 200 or an external storage device. Alternatively, the processing may be implemented by dedicated hardware.

In the second embodiment, when various maintenance requests described in FIG. 4 of the first embodiment are issued, maintenance request reservation processing is executed.

FIG. 10 is a flow chart showing maintenance request reservation processing executed by the printing apparatus according to the second embodiment of the present invention.

In step S200, a flag representing the type of maintenance (in this case, wiping, predischarge, cleaning or capping) is stored in an internal variable on a RAM 3. In step S201, a maintenance request flag on the RAM 3, which is used to notify the host computer 200 of the maintenance request when the host computer 200 inquires about the status of the printing apparatus, is turned ON. Then, the processing is ended.

The host computer 200 periodically executes main processing to confirm the status of the printing apparatus 100. This main processing will be described with reference to FIG. 11.

FIG. 11 is a flow chart showing main processing executed by the host computer according to the second embodiment of the present invention.

In step S100, the CPU of the host computer 200 initializes the system. In step S101, polling processing is executed to inquire about the status of the printing apparatus 100. In this polling processing, a status request command is transmitted to the printing apparatus 100.

In step S102, it is determined whether the status of the printing apparatus 100, which is obtained by polling processing, contains a maintenance request flag. If a maintenance request flag is present (YES in step S102), the flow advances to step S103 to execute processing shown in FIG. 8 of the first embodiment. If no maintenance request flag is present (NO in step S102), the flow advances to step S104.

In step S104, the presence/absence of input operation is determined. If no input operation is performed (NO in step S104), the flow returns to step S101. If input operation is performed (YES in step S104), the flow advances to step S105 to execute input operation processing corresponding to the input operation. Then, the flow returns to step S101.

Upon receiving the status request command from the host computer 200, the printing apparatus 100 executes status notification processing. This status notification processing will be described with reference to FIG. 12.

FIG. 12 is a flow chart showing status notification processing executed by the printing apparatus according to the second embodiment of the present invention.

In step S210, upon receiving the status request command from the host computer 200, the CPU 1 determines whether the maintenance request flag on the RAM 3 is ON. If the maintenance request flag is ON (YES in step S210), the flow advances to step S211 to transmit a status containing the maintenance request flag to the host computer 200. If the maintenance request flag is OFF (NO in step S210), the flow advances to step S212 to transmit a normal status to the host computer 200.

In the second embodiment, the printing apparatus 100 executes processing shown in FIG. 4 of the first embodiment on the basis of print data from the host computer 200 until the status notification processing is executed, as in the first embodiment. When a maintenance execution command is received from the host computer 200, the printing apparatus 100 executes processing shown in FIG. 6 of the first embodiment.

As described above, according to the second embodiment, the status of the printing apparatus 100 is monitored by polling processing. On the basis of the monitor result, execution of maintenance of the printing apparatus 100 can be controlled. Especially, the host computer 200 can perform polling processing assuming that a maintenance execution request may be received. Hence, execution of maintenance of the printing apparatus 100 can be controlled at a more appropriate timing.

The present invention can also be achieved by supplying a software program (in the embodiments, a program corresponding to the flow charts shown in the drawings), which implements the functions of the above-described embodiments, to the system or apparatus directly or from a remote site, and causing the computer of the system or apparatus to read out and execute the supplied program codes. In this case, the present invention only needs to have the functions of the program. The form of program is not always necessary.

The program codes which are installed in the computer to realize the functional processing of the present invention by that computer also implement the present invention by themselves. That is, the present invention also incorporates the computer program that implements the functional processing of the present invention.

In this case, the present invention only needs to have the functions of the program. The program can have any form such as object codes, a program to be executed by an interpreter, or script data to be supplied to an OS.

Examples of recording media for supplying the program are a floppy (registered trademark) disk, hard disk, optical disk, magnetooptical disk, MO, CD-ROM, CD-R, CD-RW, magnetic tape, nonvolatile memory card, ROM, and DVD (DVD-ROM or DVD-R).

The program can also be supplied by connecting the client computer to a homepage on the Internet using the browser of the computer and downloading the computer program of the present invention or a compressed file including an auto-install function from the homepage to a recording medium such as a hard disk. Alternatively, the program codes that construct the program of the present invention may be divided into a plurality of files, and the respective files may be downloaded from different homepages. That is, the present invention also incorporates a WWW server which causes a plurality of users to download the program files that implement the functional processing of the present invention in computers.

The present invention can also be implemented by encrypting the program of the present invention, storing the encrypted program in a storage medium such as a CD-ROM, distributing the media to users, allowing any user who satisfies predetermined conditions to download key information necessary for decrypting the program from a homepage through the Internet, and causing the user to use the key information to execute the encrypted program and install it in the computer.

The functions of the above-described embodiments are implemented not only by causing the computer to read out and execute the program but also by causing the OS running on the computer to execute part or all of actual processing on the basis of the instructions of the program.

The functions of the above-described embodiments are also implemented when the program read out from the recording medium is written in the memory of a function expansion board inserted into the computer or a function expansion unit connected to the computer, and the CPU of the function expansion board or function expansion unit performs part or all of actual processing on the basis of the instructions of the program.

As many apparently widely different embodiments of the present invention can be made without departing from the spirit and scope thereof, it is to be understood that the invention is not limited to the specific embodiments thereof except as defined in the appended claims.

What is claimed is:

1. A printing apparatus having a maintenance operation of executing maintenance of components or mechanisms in the apparatus, comprising:
detection means for detecting an execution timing of maintenance in the apparatus;
transmission means for transmitting to an external device a first command that requests execution of the maintenance on the basis of a detection result from said detection means;
reception means for receiving from the external device a second command which corresponds to the first command and instructs execution of the maintenance; and
execution means for, when said reception means receives the second command, executing maintenance to be executed.

2. The apparatus according to claim 1, wherein
the apparatus further comprises holding means for, when said detection means detects the execution timing of the maintenance, holding a flag representing a type of the maintenance, and
when said receiving means receives the second command, said execution means executes maintenance corresponding to the flag held by said holding means as the maintenance to be executed.

3. An information processing apparatus for controlling a printing apparatus having a maintenance operation of executing maintenance of components or mechanisms in the apparatus, comprising:
reception means for receiving a first command that requests execution of maintenance from the printing apparatus;
determination means for, upon receiving the first command, determining whether the maintenance can be executed; and
transmission means for transmitting a second command that instructs execution of the maintenance to the printing apparatus on the basis of a determination result from said determination means.

4. A printing system having a printing apparatus having a maintenance operation of executing maintenance of components or mechanisms in the apparatus and an external device for controlling the printing apparatus, wherein
the printing apparatus comprises
detection means for detecting an execution timing of maintenance in the apparatus,
first transmission means for transmitting to the external device a first command that requests execution of the maintenance on the basis of a detection result from said detection means,
first reception means for receiving from the external device a second command which corresponds to the first command and instructs execution of the maintenance, and
execution means for, when said first reception means receives the second command, executing maintenance to be executed, and
the external device comprises
second reception means for receiving the first command from the printing apparatus,
determination means for, upon receiving the first command, determining whether the maintenance can be executed, and
second transmission means for transmitting the second command to the printing apparatus on the basis of a determination result from said determination means.

5. A printing apparatus having a maintenance operation of executing maintenance of components or mechanisms in the apparatus, comprising:
detection means for detecting an execution timing of maintenance in the apparatus;
holding means for holding a flag to request execution of the maintenance on the basis of a detection result from said detection means;
transmission means for receiving from an external device a status request for the printing apparatus and, when said holding means holds the flag, transmitting a status containing the flag to the external device;
reception means for receiving from the external device a command which corresponds to the flag and instructs execution of the maintenance; and
execution means for, when said reception means receives the command, executing maintenance to be executed.

6. The apparatus according to claim 5, wherein
when said detection means detects the execution timing of the maintenance, said holding means also holds a flag representing a type of the maintenance, and
when said reception means receives the command, said execution means executes maintenance corresponding to the flag held by said holding means as the maintenance to be executed.

7. The apparatus according to any one of claims 1, 2, 5, and 6, wherein
the printing apparatus is an inkjet printing apparatus, and
the maintenance includes at least an arbitrary combination of wiping operation, predischarge operation, cleaning operation, and capping operation for a printhead of the printing apparatus.

8. An information processing apparatus for controlling a printing apparatus having a maintenance operation of executing maintenance of components or mechanisms in the apparatus, comprising:
reception means for requesting and receiving a status of the printing apparatus;
determination means for, when a flag to request execution of maintenance is contained in the status, determining whether the maintenance can be executed; and
transmission means for transmitting a command that instructs execution of the maintenance to the printing apparatus on the basis of a determination result from said determination means.

9. A printing system having a printing apparatus having a maintenance operation of executing maintenance of components or mechanisms in the apparatus and an external device for controlling the printing apparatus, wherein
the printing apparatus comprises
detection means for detecting an execution timing of maintenance in the apparatus,
holding means for holding a flag to request execution of the maintenance on the basis of a detection result from said detection means,
first transmission means for receiving from the external device a status request for the printing apparatus and, when said holding means holds the flag, transmitting a status containing the flag to the external device,
first reception means for receiving a command which corresponds to the flag and instructs execution of the maintenance, and
execution means for, when said first reception means receives the command, executing maintenance to be executed, and
the external device comprises
second reception means for requesting and receiving a status of the printing apparatus,
determination means for, when the flag is contained in the status, determining whether the maintenance can be executed, and
second transmission means for transmitting a command that instructs execution of the maintenance to the printing apparatus on the basis of a determination result from said determination means.

10. A method of controlling a printing apparatus having a maintenance operation of executing maintenance of components or mechanisms in the apparatus, comprising:
a detection step of detecting an execution timing of maintenance in the apparatus;
a transmission step of transmitting to an external device a first command that requests execution of the maintenance on the basis of a detection result in the detection step;
a reception step of receiving from the external device a second command which corresponds to the first command and instructs execution of the maintenance; and
an execution step of, when the second command is received in the second step, executing maintenance to be executed.

11. The method according to claim 10, wherein
the method further comprises a holding step of, when the execution timing of the maintenance is detected in the detection step, holding a flag representing a type of the maintenance in a recording medium, and
in the execution step, when the second command is received in the reception step, maintenance corresponding to the flag held in the storage medium is executed as the maintenance to be executed.

12. A method of controlling an information processing apparatus for controlling a printing apparatus having a maintenance operation of executing maintenance of components or mechanisms in the apparatus, comprising:
a reception step of receiving a first command that requests execution of maintenance from the printing apparatus;
a determination step of, upon receiving the first command, determining whether the maintenance can be executed; and
a transmission step of transmitting a second command that instructs execution of the maintenance to the printing apparatus on the basis of a determination result in the determination step.

13. A method of controlling a printing apparatus having a maintenance operation of executing maintenance of components or mechanisms in the apparatus, comprising:
a detection step of detecting an execution timing of maintenance in the apparatus;
a holding step of holding a flag to request execution of the maintenance in a recording medium on the basis of a detection result in the detection step;
a transmission step of receiving from an external device a status request for the printing apparatus and, when the flag is held in the holding step, transmitting a status containing the flag to the external device;
a reception step of receiving a command which corresponds to the flag and instructs execution of the maintenance; and
an execution step of, when the command is received in the reception step, executing maintenance to be executed.

14. The method according to claim 13, wherein
in the holding step, when the execution timing of the maintenance is detected in the detection step, a flag representing a type of the maintenance is also held in the recording medium, and
in the execution step, when the command is received in the reception step, maintenance corresponding to the flag held in the storage medium is executed as the maintenance to be executed.

15. The method according to any one of claims 10, 11, 13, and 14, wherein
the printing apparatus is an inkjet printing apparatus, and
the maintenance includes at least an arbitrary combination of wiping operation, predischarge operation, cleaning operation, and capping operation for a printhead of the printing apparatus.

16. A method of controlling an information processing apparatus for controlling a printing apparatus having a maintenance operation of executing maintenance of components or mechanisms in the apparatus, comprising:
a reception step of requesting and receiving a status of the printing apparatus;
a determination step of, when a flag to request execution of maintenance is contained in the status, determining whether the maintenance can be executed; and
a transmission step of transmitting a command that instructs execution of the maintenance to the printing apparatus on the basis of a determination result in the determination step.
